(19) United States
(12) Patent Application Publication
(10) Pub. No.: US 2024/0241340 A1
(43) Pub. Date: Jul. 18, 2024

(54) LENS UNIT AND LENS BARREL EQUIPPED WITH SAME

(71) Applicant: Panasonic Intellectual Property Management Co., Ltd., Osaka (JP)

(72) Inventors: Yuichiro KIMOTO, Osaka (JP); Tetsuya MORITA, Osaka (JP); Masayuki SHODAI, Osaka (JP); Naoki YOSHIKAWA, Osaka (JP); Takeshi SAKAKIBARA, Osaka (JP)

(73) Assignee: Panasonic Intellectual Property Management Co., Ltd., Osaka (JP)

(21) Appl. No.: 18/534,582

(22) Filed: Dec. 9, 2023

(30) Foreign Application Priority Data
Jan. 12, 2023 (JP) 2023-003155

(51) Int. Cl. G02B 7/02; G02B 1/11

(52) U.S. Cl. CPC G02B 7/025; G02B 1/11

(57) ABSTRACT

A first lens group unit 20 includes a lens L2, a blacked-out portion L2b, a lens frame 22, and an injection hole 21a. The lens L2 has a thrust surface L2d that intersects the direction of the optical axis AX, a thrust surface L2c on the opposite side from the thrust surface L2d, and an edge surface L2e that connects the thrust surface L2d and the thrust surface L2c. The blacked-out portion L2b is provided to an edge surface L2e of the lens L2, and suppresses the reflection of light incident on the lens L2 on the edge surface L2e. The lens frame 22 has a substantially cylindrical shape, and holds the lens L2, which is inserted from the thrust surface L2d side along the cylindrical inner peripheral surface 22a. The injection hole 21a is used to bond the lens L2 and the lens frame 22 with an adhesive applied to the thrust surface L2c.

### CROSS-REFERENCE TO RELATED APPLICATIONS

This application claims priority to Japanese Patent Application No. 2023-003155 filed on Jan. 12, 2023. The entire disclosure of Japanese Patent Application No. 2023-003155 is hereby incorporated herein by reference.

### BACKGROUND

### Technical Field

The present disclosure relates to a lens unit that holds a lens, and to a lens barrel equipped with this lens unit.

### Description of the Related Art

A lens unit for holding lenses is included in camera lens barrels, projectors, smartphones, and the like.

For example, Patent Literature 1 discloses lens unit that has an imaging lens; a cylindrical lens barrel that holds the imaging lens; an imaging element; an imaging element holder that holds the imaging element and mates with the lens barrel so as to be able to rotate around the optical axis of the imaging lens and to be able to move in the optical axis direction; a cylindrical cam that is formed on either the lens barrel or the imaging element holder and has on its upper or lower surface an annular cam surface centered on the optical axis of the imaging lens; and a contact member that is formed on the other of the lens barrel and the imaging element holder and makes contact with the cam surface of the cylindrical cam when the lens barrel has been mated with the imaging element holder, wherein the lens barrel and the imaging element holder are fixed after focusing is performed through relative rotation of the lens barrel and the imaging element holder.

### CITATION LIST

### Patent Literature

Patent Literature 1: JP-A 2006-222473

### SUMMARY

### Problem to be Solved by the Disclosure

However, with the structure of the conventional lens unit described above, the lens fixed to the lens frame is fixed so that its end surface (edge surface) is bonded to the inner peripheral surface of the lens frame.

At this point, an antireflective film, such as black coating, is sometimes provided at the end surface of the lens so that the light incident on the lens will not be reflected at the end surface.

When fixing a lens to a lens frame, if an adhesive is applied to the end face of the lens and the lens is fixed to the lens frame, there is the risk that a tensile force will be generated radially outward due to curing shrinkage of the adhesive or a difference in the coefficient of linear expansion between the lens and the adhesive if the adhesive strength of the black coating is low, which may cause the black coating to peel off.

It is an object of the present disclosure to provide a lens unit with which peeling of an antireflective film can be effectively prevented in a configuration in which a black coating or other such antireflective film is provided on the end face of the lens, as well as a lens barrel equipped with this lens unit.

### Means for Solving Problem

The lens unit according to the present disclosure comprises a lens, an antireflective film, a lens frame, and a first adhesive part. The lens has a first thrust surface that intersects the optical axis direction, a second thrust surface on the opposite side from the first thrust surface, and an end surface that connects the first thrust surface and the second thrust surface. The antireflective film is provided on the end face of the lens, and suppresses the reflection of light incident on the lens at the end face. The lens frame has a substantially cylindrical shape, into which the lens is inserted from the first thrust surface side along the substantially cylindrical inner peripheral surface, and holds the lens. The first adhesive portion bonds the lens and the lens frame with an adhesive applied to the first thrust surface or the second thrust surface.

### Effects

With the lens unit according to the present disclosure, peeling of the antireflective film can be effectively prevented in a configuration in which an antireflective film such as a black coating is provided on the end face of the lens.

### BRIEF DESCRIPTION OF THE DRAWINGS

FIG. 1 is an exploded oblique view of the configuration of a lens barrel including a first lens group unit according to an embodiment of the present disclosure;

FIG. 2 is an exploded oblique view of the configuration of the first lens group unit included in the lens barrel of FIG. 1;

FIG. 3A is a top view of the first lens group unit in FIG. 2;

FIG. 3B is a cross-sectional view along the F-F line in FIG. 3A;

FIG. 4 is a detail cross-sectional view of the fixed portion of the lens in FIG. 3B;

FIG. 5 is a top view of the configuration of the first lens group unit in FIG. 3A when the lens closest to the subject side has been removed;

FIG. 6A is a top view of the first lens group unit in another embodiment of the present disclosure;

FIG. 6B is a cross-sectional view along the G-G line in FIG. 6A;

FIG. 7 is a detail cross-sectional view of the fixed portion of the lens in FIG. 6B; and

FIG. 8 is a rear view of the opposite side of the first lens group unit in FIG. 6A.

### DETAILED DESCRIPTION OF THE EMBODIMENT

An embodiment will now be described in detail with reference to the drawings as appropriate. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

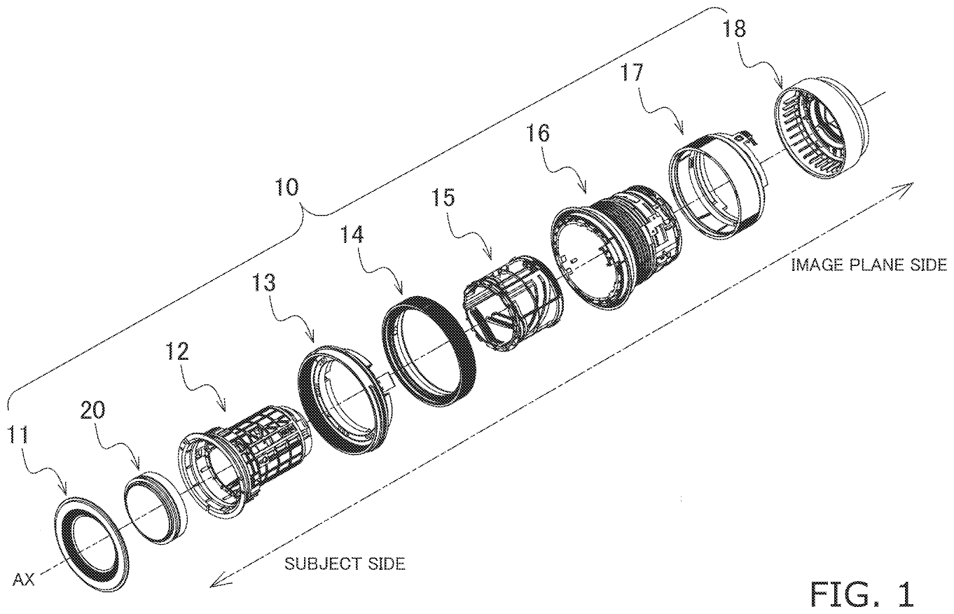

The first lens group unit 20 (lens unit) and the lens barrel 10 equipped with this lens unit in an embodiment of the present disclosure will now be described through reference to FIGS. 1 to 5

### (1) Configuration of Lens Barrel 10

The lens barrel 10 in this embodiment is removably attached to a camera body (not shown), and as shown in FIG. 1, comprises a trim ring 11, the first lens group unit 20 (lens unit), a second, third, and fourth lens group unit 12, a filter ring 13, a focus ring 14, a cam frame 15, a ring mount base 16, a zoom ring 17, and a rear frame unit 18 (mounting unit).

The trim ring 11 is a substantially annular member that constitutes part of the external appearance of the lens barrel 10, and is attached to the surface on the subject side in the optical axis AX direction of the first lens group unit 20, as shown in FIG. 1.

The first lens group unit 20 holds a plurality of first lens group lenses (lenses L1 to L4), and as shown in FIG. 1, is attached on the subject side in the optical axis AX direction of the first lens group unit 20.

The configuration of the first lens group unit 20 will be described in detail below.

As shown in FIG. 1, the second, third, and fourth lens group unit 12 is a substantially cylindrical member that internally holds a second lens group lens, a third lens group lens, and a fourth lens group lens.

As shown in FIG. 1, the filter ring 13 is a substantially annular member and is attached to the ring mount base 16.

The focus ring 14 is a substantially annular member mounted on the outer peripheral surface of the ring mount base 16, as shown in FIG. 1. When the focus ring 14 is turned, a drive mechanism such as a motor (not shown) is driven, and the focus mechanism is made to function when the relative positions of the plurality of lenses included in the lens barrel 10 change.

As shown in FIG. 1, the cam frame 15 is disposed on the outer peripheral surface side of the second, third, and fourth lens group units 12 and on the inner peripheral surface side of the ring mount base 16, and has a plurality of cam grooves formed in a substantially cylindrical main body portion. When the cam frame 15 is turned relative to the second, third, and fourth lens group units 12 and the ring mount base 16, the cam pins, etc., engaged with the plurality of cam grooves move along the cam grooves, and this changes the relative positions of the lenses.

As shown in FIG. 1, the ring mount base 16 is a substantially cylindrical member provided to hold the filter ring 13, the focus ring 14, the zoom ring 17, and the rear frame unit 18, and the focus ring 14 and the zoom ring 17 are rotatably mounted around the outer peripheral portion thereof.

As shown in FIG. 1, the zoom ring 17 is a substantially annular member that is mounted to the outer peripheral surface of the ring mount base 16, and when turned by the user, performs a zoom operation to change the relative positions of the lenses included in the lens barrel 10.

As shown in FIG. 1, the rear frame unit 18 is a substantially cylindrical member that is disposed the closest to the image plane in the optical axis AX direction of all the parts constituting the lens barrel 10, and is mounted to a camera body (not shown).

### (2) Configuration of First Lens Group Unit 20

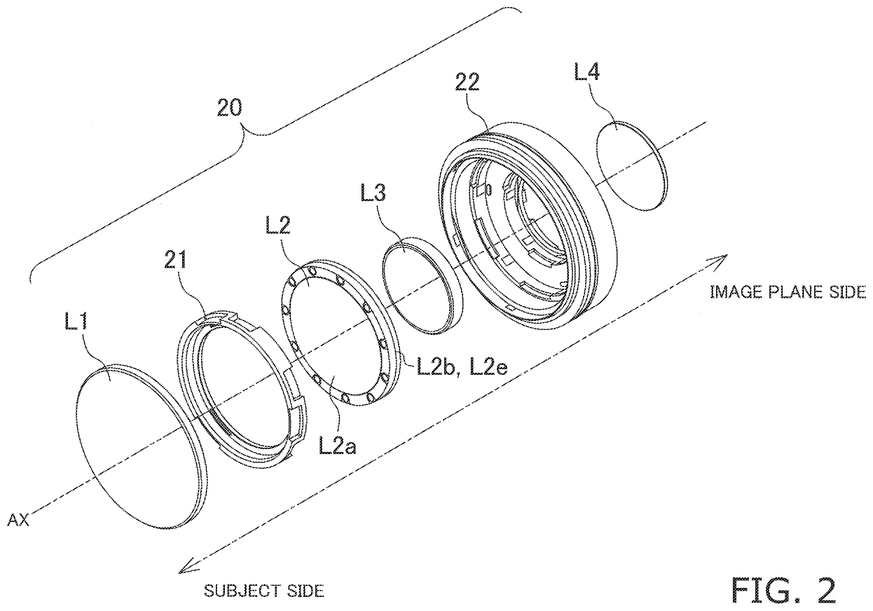

As shown in FIG. 2, the first lens group unit 20 (lens unit) comprises four lenses L1, L2, L3, and L4, a fixing frame 21, and a lens frame 22.

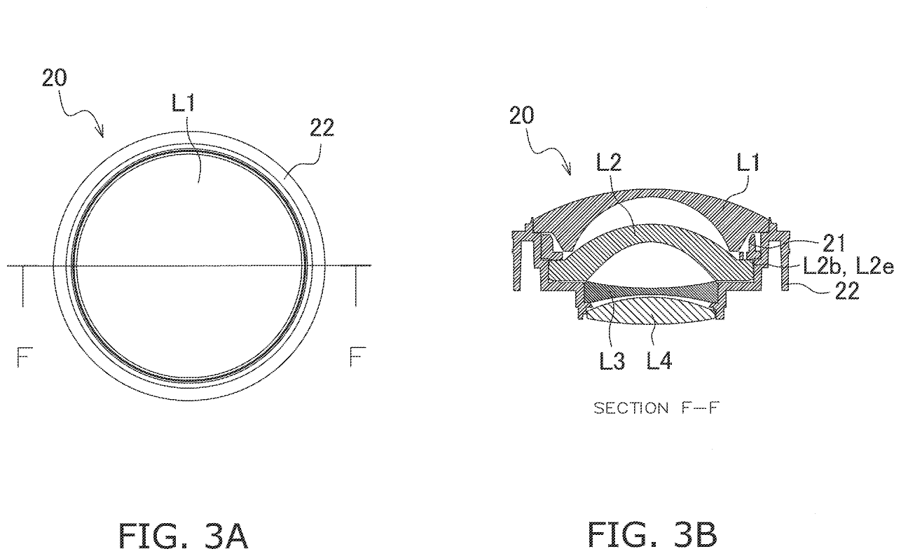

As shown in FIG. 2, the four lenses L1, L2, L3, and L4 are disposed in that order starting from the object side in the optical axis AX direction, and guide the light incident on the first lens group unit 20 toward the image plane side. Also, the lenses L1, L2, L3, and L4 are each fixed to the lens frame 22, as shown in FIGS. 3A and 3B.

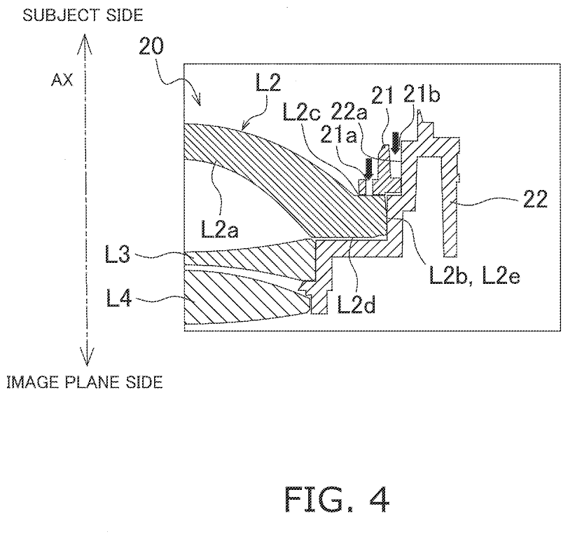

The fixing frame 21 is a substantially annular member for fixing the lens L2 to the lens frame 22, and as shown in FIGS. 3B and 4, is provided on the inner peripheral surface 22a side of the lens frame 22. As shown in FIG. 4, the fixing frame 21 is fixed to the thrust surface L2c of the lens L2 at the surface on the image plane side in the optical axis AX direction, and is fixed to the inner peripheral surface of the lens frame 22 at its outer peripheral surface.

Consequently, the lens L2 is fixed to the inner peripheral surface 22a of the lens frame 22 via the fixing frame 21.

For the sake of description, FIG. 4 does not depict the lens L1 provided closest to the subject in the optical axis AX direction.

Also, the fixing frame 21 has an injection hole 21a (first adhesive part, first injection hole) and an injection part 21b.

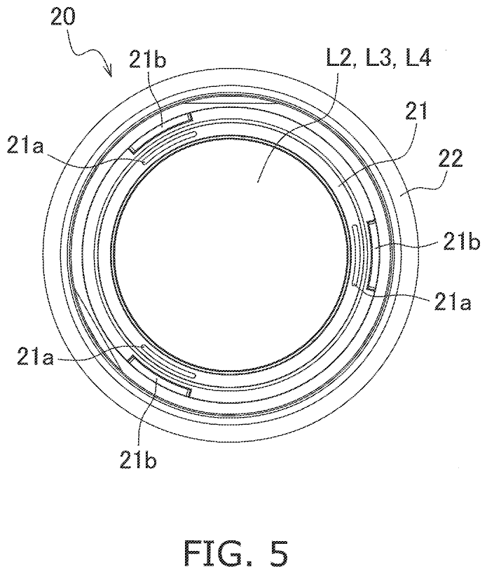

As shown in FIG. 4, the injection hole 21a is a through-hole formed in the surface of the fixing frame 21 that is opposite the thrust surface L2c of the lens L2, and is used to inject an adhesive for bonding the thrust surface L2c of the lens L2 and the fixing frame 21 (see the downward arrow on the left side of the drawing). Also, as shown in FIG. 5, three injection holes 21a are provided at substantially equal angular intervals (about 120 degrees) in the circumferential direction of the substantially annular fixing frame 21.

Consequently, the lens L2 can be fixed to the fixing frame 21 at three points in the circumferential direction by the adhesive injected into the three injection holes 21a.

As shown in FIG. 4, the injection part 21b is a gap formed between the inner peripheral surface 22a of the lens frame 22 and the outer peripheral surface of the fixing frame 21, into which the adhesive is injected (see the downward arrow on the right side in the drawing). Also, as shown in FIG. 5, three injection parts 21b are provided at substantially equal angular intervals (about 120 degrees) in the circumferential direction of the substantially annular fixing frame 21.

Consequently, the fixing frame 21 can be fixed to the lens frame 22 at three points in the circumferential direction by the adhesive injected into the three injection parts 21b. As a result, the lens L2 can be fixed to the inner peripheral surface 22a side of the lens frame 22 via the fixing frame 21.

As shown in FIG. 2, the lens frame 22 is a substantially cylindrical member, and as shown in FIG. 3B, holds the lenses L1, L2, L3, and L4 on the inner peripheral surface 22a side at positions each having a different inside diameter.

Here, the lens L2 to which the lens fixing structure of the present disclosure is applied in the first lens group unit 20 of this embodiment will be described in detail.

The lens L2 is, for example, a resin lens formed by injection molding or the like, and is provided between the lenses L1 and L3 in the optical axis AX direction, as shown in FIG. 3B. Also, as shown in FIGS. 3B and 4, the lens L2 has a lens portion L2a, a blacked-out portion L2b (antireflective film), a thrust surface L2c, a thrust surface L2d, and an edge surface L2e (end surface).

The lens portion L2a is a portion that transmits the light of the lens L2, and has a convex shape that protrudes toward the subject in the optical axis AX direction, as shown in FIGS. 3B and 4.

The blacked-out portion L2b is formed by applying a paint or the like that does not readily reflect light, such as black ink, in order to make it less likely that light incident on the lens L2 will be reflected at the edge surface L2e, resulting in stray light.

The thrust surface L2c (second thrust surface) is provided on the outer peripheral portion of the lens portion L2a, is a plane that intersects the optical axis AX direction, and is provided as the surface of the lens L2 on the subject side. The fixing frame 21 is fixed to the thrust surface L2c of the lens L2 by injecting an adhesive into the three injection holes 21a formed in the fixing frame 21 as described above.

The thrust surface L2d (first thrust surface) is provided to the outer peripheral portion of the lens portion L2a on the image plane side of the lens L2 in the optical axis AX direction, and is a plane on the opposite side from the thrust surface L2c of the lens L2. When the lens L2 is attached to the lens frame 22, it is mounted to the inner peripheral surface 22a of the lens frame 22 from the thrust surface L2d side.

The edge surface L2e (end surface) is the end surface of the lens L2 that connects the thrust surface L2c and the thrust surface L2d, and is provided with the antireflective blacked-out portion L2b. This makes it less likely that light incident on the lens L2 will be reflected at the edge surface L2e and cause stray light.

Also, with the first lens group unit 20 in this embodiment, the lens L2 is fixed to the lens frame 22 without applying any adhesive to the blacked-out portion L2b provided on the edge surface L2e of the lens L2. Accordingly, if the adhesive strength of the blacked-out portion L2b to the edge surface L2e of the lens L2 is weak, this will prevent peeling of blacked-out portion L2b attributable to radially outward tensile force caused by the difference in the coefficient of linear expansion between the lens L2 and the adhesive.

### Main Features

The first lens group unit 20 of this embodiment comprises the lens L2, the blacked-out portion L2b, the lens frame 22, and the injection hole 21a. The lens L2 has the thrust surface L2d that intersects the direction of the optical axis AX, the thrust surface L2c on the opposite side from the thrust surface L2d, and the edge surface L2e that connects the thrust surface L2d and the thrust surface L2c. The blacked-out portion L2b is provided on the edge surface L2e of the lens L2, and suppresses reflection of light incident on the lens L2 at the edge surface L2e. The lens frame 22 has a substantially cylindrical shape, receives the insertion of the lens L2 from the thrust surface L2d side along the cylindrical inner peripheral surface 22a, and holds the lens L2. The injection hole 21a is used to bond the lens L2 and the lens frame 22 with an adhesive that is applied to the thrust surface L2d or the thrust surface L2c.

Consequently, in the lens L2, the fixing frame 21 fixed to the thrust surface L2c is fixed to the inner peripheral surface 22a of the lens frame 22 without applying any adhesive to the blacked-out portion L2b provided on the edge surface L2e, and this allows the lens L2 to be fixed to the lens frame 22.

As a result, in a configuration in which an antireflective film such as the blacked-out portion L2b is provided on the edge surface L2e of the lens L2, peeling of the blacked-out portion L2b can be effectively prevented.

### Other Embodiments

An embodiment of the present disclosure was described above, but the present disclosure is not limited to or by the above embodiment, and various changes can be made without departing from the gist of the disclosure.

### (A)

In the above embodiment, an example was given in which the lens L2 was fixed to the inner peripheral surface of the lens frame 22 via the substantially annular fixing frame 21. However, the present disclosure is not limited to this.

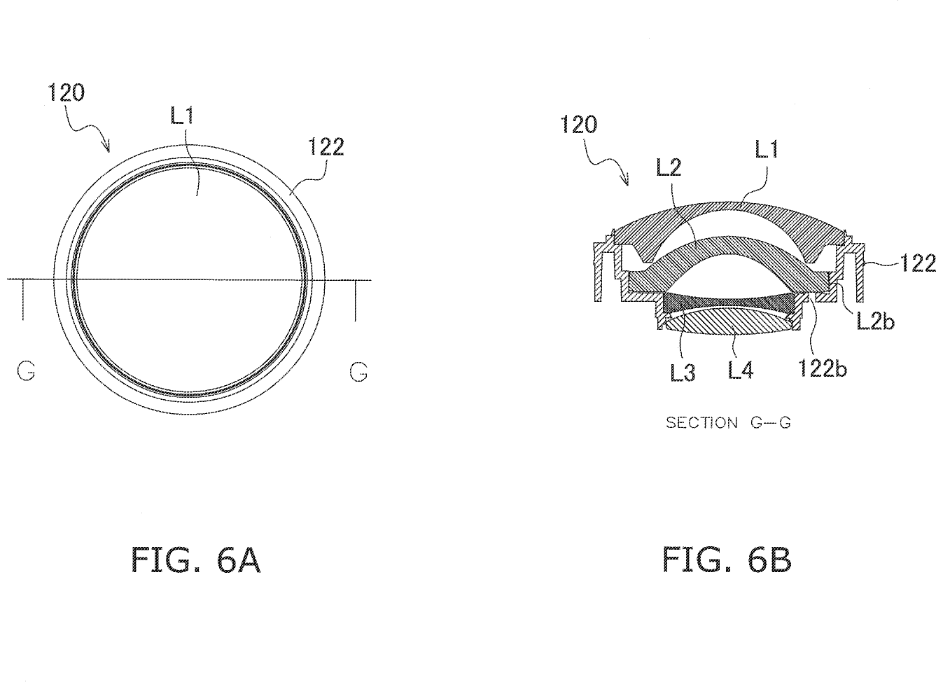

For example, as shown in FIGS. 6A and 6B, a first lens group unit 120 (lens unit) in which the lens L2 is fixed to the lens frame 122 may be used instead of using a fixing frame.

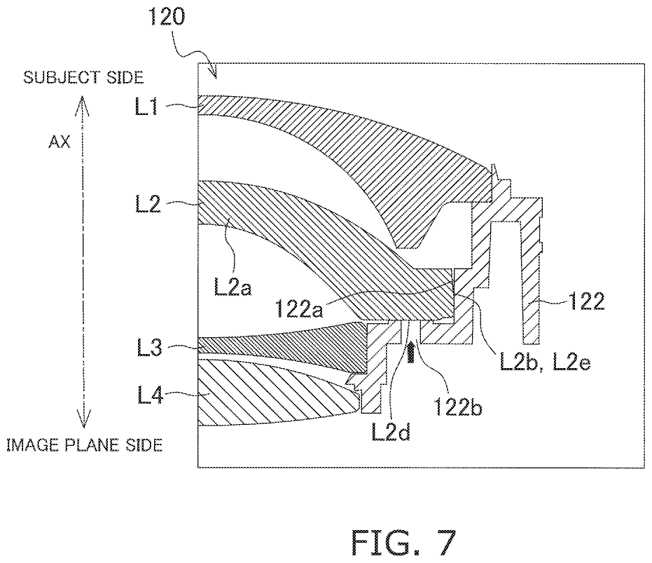

As shown in FIG. 7, in the first lens group unit 120, an adhesive is injected into injection holes 122b (second injection hole) formed in the surface of the lens frame 122 that is opposite the thrust surface L2d (first thrust surface) of the lens L2.

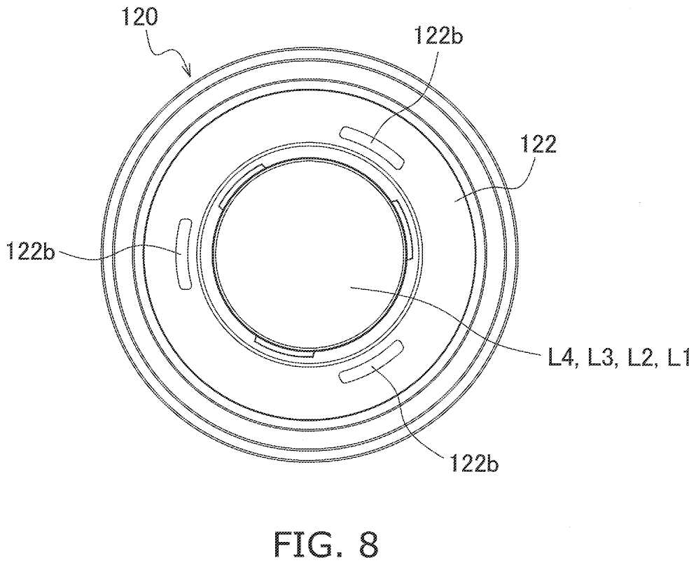

As shown in FIG. 7, each injection hole 122b is a hole that passes through a plane substantially perpendicular to the optical axis AX direction of the lens frame 122, and as shown in FIG. 8, three of these are provided at equal angular intervals. Consequently, the adhesive is injected from the image plane side in the optical axis AX direction through the injection holes 122b, and the lens L2 is fixed to the inner peripheral surface 122a of the lens frame 122.

Here again, since no adhesive is applied to the blacked-out portion L2b provided on the edge surface L2e of the lens L2, peeling of the blacked-out portion and other such problems can be prevented.

### (B)

In the above embodiment, an example was given in which the present disclosure was applied to the first lens group unit (lens unit) 20 included in the lens barrel 10 that was removably attached to the camera body. However, the present disclosure is not limited to this.

For example, in addition to a lens barrel that is removably attached to a camera body, the present disclosure may also be applied to a lens unit that is installed in a projector, a compact digital camera, a smartphone, a tablet terminal, or the like.

### (C)

In the above embodiment, an example was given in which three injection holes 21a into which adhesive was injected were provided at approximately equal angular intervals in the circumferential direction of the fixing frame 21. However, the present disclosure is not limited to this.

For example, two or four or more injection holes into which an adhesive is injected may be provided in the circumferential direction of the fixing frame.

Also, there may be just one substantially annular injection hole formed along the circumferential direction of the fixing frame.

### (D)

In the above embodiment, an example was given in which three injection parts 21b into which adhesive was injected were provided at approximately equal angular intervals in the circumferential direction of the fixing frame 21. However, the present disclosure is not limited to this.

For example, two or four or more injection parts into which an adhesive is injected may be provided in the circumferential direction of the fixing frame.

Also, there may be just one substantially annular recess formed as the injection part along the circumferential direction of the fixing frame.

### (E)

In the above embodiment, an example was given in which, out of the plurality of lenses L1 to L4 included in the first lens group unit 20, the lens L2, which was the second lens from the subject side in the optical axis AX direction, was fixed to the lens frame 22. However, the present disclosure is not limited to this.

For example, the present disclosure may be applied to a structure in which lenses included in a lens unit other than the first lens group unit are fixed to a lens frame.

Also, the present disclosure may be applied to a structure in which another of the lenses included in a first lens group unit is fixed to the lens frame.

### (F)

In the above embodiment, an example was given in which ink or another such coating was applied as the antireflective film provided to the edge surface L2e of the lens L2. However, the present disclosure is not limited to this.

For example, the configuration may be one in which a coating other than ink is applied, or one in which a tape-like film is affixed.

### (G)

In the above embodiment, an example was given in which the lens L2 made of a resin or the like was used as a lens included in the lens unit of the present disclosure. However, the present disclosure is not limited to this.

For example, the lenses included in the lens unit of the present disclosure are not limited to being made of resin, and may instead be made of glass.

### INDUSTRIAL APPLICABILITY

The lens unit of the present disclosure exhibits the effect that peeling of an antireflective film can be effectively prevented in a configuration in which a black coating or other such antireflective film is provided on the end face of the lens, and therefore can be widely applied to optical equipment such as camera lens barrels, projectors, small cameras, and smartphones in which a lens unit including lenses is installed.

### REFERENCE SIGNS LIST

10 lens barrel
11 trim ring
12 second, third, and fourth lens group unit
13 filter ring
14 focus ring
15 cam frame
16 ring mount base
17 zoom ring
18 rear frame unit (attachment unit)
20 first lens group unit (lens unit)
21 fixing frame
21a injection hole (first adhesive part, first injection hole)
21b injection part
22 lens frame
22a inner peripheral surface
120 first lens group unit (lens unit)
122 lens frame
122a inner peripheral surface
122b injection hole (second injection hole)
AX optical axis
L1 lens
L2 lens
L2a lens part
L2b blacked-out area (antireflective film)
L2c thrust surface (second thrust surface)
L2d thrust surface (first thrust surface)
L2e edge surface (end surface)
L3 lens
L4 lens

1. A lens unit, comprising:
a lens having a first thrust surface that intersects an optical axis direction, a second thrust surface on an opposite side from the first thrust surface, and an end surface that connects the first thrust surface and the second thrust surface;
an antireflective film that is provided to the end surface of the lens and is configured to suppress a reflection of light incident on the lens at the end surface;
a lens frame that has a substantially cylindrical shape, into which the lens is inserted from a side of the first thrust surface along the substantially cylindrical inner peripheral surface, and holds the lens; and
a first adhesive part that bonds the lens to the lens frame with an adhesive applied to the first thrust surface or the second thrust surface.

2. The lens unit according to claim 1,
further comprising a fixing frame that is provided on an inner peripheral surface of the lens frame,
wherein the lens is fixed to the inner peripheral surface of the lens frame via the fixing frame.

3. The lens unit according to claim 2,
wherein the fixing frame further has a first injection hole into which is injected an adhesive for bonding the fixing frame and the second thrust surface of the lens.

4. The lens unit according to claim 2,
wherein the fixing frame further has an injection part into which is injected an adhesive between the inner peripheral surface of the lens frame and an outer peripheral surface of the fixing frame.

5. The lens unit according to claim 1,
wherein the lens frame further has a second injection hole into which an adhesive is injected, and
the first thrust surface of the lens is bonded to the lens frame by the adhesive injected into the second injection hole.

6. The lens unit according to claim 1,
wherein the antireflective film is a blacked-out portion coated with a paint that suppresses the reflection of light.

7. The lens unit according to claim 1,
wherein the lens is a resin lens.

8. A lens barrel, comprising:
the lens unit according to claim 1; and
an attachment unit that is attached to a mounting unit of a camera body.
